(19) United States
(12) Patent Application Publication
(10) Pub. No.: US 2026/0088631 A1
(43) Pub. Date: Mar. 26, 2026

(54) ENERGY MANAGEMENT SYSTEM FOR DISPARATE FACILITIES

(71) Applicant: QSecGrid, Inc., New York, NY (US)

(72) Inventors: Gordon R. WINSTON, Katonah, NY (US); John-Philip GALINSKI, Forest Hills, NY (US); Nigel WALKER, Ponteland (GB); Mark THOMPSON, Blyth (GB); Patrick J.D. SANTOS, Kirkland, WA (US)

(21) Appl. No.: 19/274,083

(22) Filed: Jul. 18, 2025

Related U.S. Application Data
(60) Provisional application No. 63/699,116, filed on Sep. 25, 2024.

(51) Int. Cl. H02J 3/46; H02J 3/00; H02J 3/38

(52) U.S. Cl. CPC H02J 3/466; H02J 3/003; H02J 3/381; H02J 2103/30; H02J 2103/35

(57) ABSTRACT

Predictive energy management across a plurality of microgrids situated at disparate facilities is disclosed. Each microgrid may include one or more distributed energy resources (DERs). Reception of profile data from these microgrids and the creation of aggregated profiles is enabled, which may incorporate the profile data, charts of accounts, energy transfer tariffs, and other energy-related attributes. An event detection engine may identify triggering events such as energy surpluses, deficits, or operational conditions, indicating a benefit to energy reallocation. A recommendation engine may generate energy allocation recommendations based on predictive models, optimizing factors like cost efficiency, carbon offset utilization, and energy availability. The recommendations may be executed through an aggregation server, which dynamically updates the aggregated profiles in real-time.

### RELATED APPLICATION

This application claims priority to a commonly owned, U.S. Provisional Patent Application No. 63/699,116, filed on Sep. 25, 2024, and titled “Predictive Energy Management”, which is herein incorporated by reference in its entirety.

### TECHNICAL FIELD

Embodiments of the present invention generally relate to energy management, and more particularly to predictive energy management across disparate facilities.

### BACKGROUND

Energy is a vital resource, integral to almost every facet of modern life, including communication, powering homes, industrial operations, transportation, and food preparation. In the commercial, industrial, and public sectors, energy drives the production of goods and the provision of services. For educational institutions, such as schools, energy is used for running classrooms, administrative buildings, and facilities, and further for providing infrastructure for teaching and learning. Given the importance of energy in maintaining operations, the schools must carefully manage energy consumption to control costs while ensuring the necessary resources are available for the educational mission held by the schools.

However, most conventional energy management systems lack a capability to effectively aggregate and optimize energy resources across multiple school campuses, especially when those campuses are geographically dispersed. The conventional energy management systems focus primarily on managing energy consumption within a single campus or building, often without the ability to share surplus energy or coordinate energy usage across different locations. This limitation is particularly evident for school districts or educational organizations that operate multiple campuses spread across large geographic areas.

Further, the conventional energy management systems do not allow the schools to aggregate and re-aggregate energy resources in a way that enables geographically disparate campuses to participate in shared energy management. Schools, as entities, are not able to efficiently transfer or redistribute energy across different campuses, even when one campus has surplus energy that could benefit another. Therefore, the schools face inefficiencies, higher energy costs, and missed opportunities for optimizing energy use across a network of campuses.

There is thus a need for a system and method for managing energies across disparate facilities in a more efficient and/or effective manner.

### BRIEF DESCRIPTION OF THE DRAWINGS

Features and advantages of embodiments of the present invention will become apparent upon consideration of the following detailed description of embodiments thereof, especially when taken in conjunction with the accompanying drawings, in which:

FIG. 1 is a block diagram depicting an exemplary computing environment that facilitates management of energies in accordance with at least one embodiment of the present invention.

FIG. 2 is an exemplary functional block diagram of components of a predictive energy management system in accordance with at least one embodiment of the present invention.

FIG. 3 is an exemplary block diagram of a chart of accounts in accordance with at least one embodiment of the present invention.

FIG. 4 is an exemplary aggregated profile using an aggregated profile generator of the predictive energy management system in accordance with at least one embodiment of the present invention.

FIG. 5 is an exemplary block diagram of an aggregation server of the predictive energy management system in accordance with at least one embodiment of the present invention.

FIG. 6 is an exemplary process of generating an aggregated profile in accordance with at least one embodiment of the present invention.

FIG. 7 is an exemplary process of generating one or more recommendations for one or more energy allocations in accordance with at least one embodiment of the present invention.

FIG. 8 is an exemplary process of executing the one or more recommended energy allocations in accordance with at least one embodiment of the present invention.

FIG. 9 a schematic diagram illustrating aspects of an example computer in accordance with at least one embodiment of the present invention.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, “includes”, “such as”, “for instance”, and “for example” mean “including but not limited to”. To facilitate understanding, like reference numerals have been used, where possible, to designate like elements common to the figures. Optional portions of the figures may be illustrated using dashed or dotted lines, unless the context of usage indicates otherwise.

### DETAILED DESCRIPTION

A method for predictive energy management may include receiving profile data for a plurality of microgrids of a plurality of disparate facilities. The plurality of microgrids may include a plurality of distributed energy resources (DERs). The method for predictive energy management may further create one or more aggregated profiles. The one or more aggregated profiles may include one or more of the received profile data and at least one chart of accounts for individual ones of the plurality of microgrids. The method for predictive energy management may further detect one or more triggering events, based on the one or more aggregated profiles, indicating a benefit to energy reallocation. The method for predictive energy management may further generate one or more recommendations for one or more energy allocations based on the aggregated profiles and the one or more detected triggering events, using one or more predictive models. The method for predictive energy management may further execute the one or more recommended energy allocations with at least one aggregation server.

A system for predictive energy management may include at least one data receiver configured at least to receive profile data for a plurality of microgrids of a plurality of disparate facilities. The plurality of microgrids may include a plurality of distributed energy resources (DERs). The system for predictive energy management may further include at least one aggregated profile generator configured at least to create one or more aggregated profiles. The one or more aggregated profiles may comprise one or more of the received profile data and at least one chart of accounts for individual ones of the plurality of microgrids. The system for predictive energy management may further include at least one event detection engine configured at least to detect one or more triggering events, based on the one or more aggregated profiles, indicating a benefit to energy reallocation. The system for predictive energy management may further include at least one recommendation engine configured at least to generate one or more recommendations for the one or more energy allocations based on the aggregated profiles and the one or more detected triggering events, using one or more predictive models. The system for predictive energy management may include at least one aggregation server configured at least to execute the one or more recommended energy allocations.

One or more computer-readable storage media collectively having thereon computer-executable instructions that, when executed, collectively cause one or more computers to at least receive profile data for a plurality of microgrids of a plurality of disparate facilities. The plurality of microgrids may include a plurality of distributed energy resources (DERs). The computer-executable instructions may further cause one or more computers to create one or more aggregated profiles. The one or more aggregated profiles may include one or more of the received profile data, and at least one chart of accounts for individual ones of the plurality of microgrids. The computer-executable instructions may further cause one or more computers to detect one or more triggering events, based on the one or more aggregated profiles, indicating a benefit to energy allocation. The computer-executable instructions may further cause one or more computers to generate one or more recommendations for the one or more energy allocations based on the aggregated profiles and the one or more detected triggering events, using one or more predictive models. The computer-executable instructions may further cause one or more computers to execute the one or more recommended energy allocations via at least one aggregation server.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein.

The term “automatic” and variations thereof, as used herein, refers to any suitable process or operation done independent of material human input when the process or operation may be performed. However, a process or operation can be automatic, even though performance of the process or operation uses material or immaterial human input, if the input may be received before performance of the process or operation. Human input may be deemed to be material if such input influences how the process or operation will be performed. Human input that consents to the performance of the process or operation may not be deemed to be “material”.

The term “determine” and variations thereof, as used herein, may include any suitable type of methodology, process, operation, and/or technique. Such determinations may include calculations and/or computations.

The term “energy source” and variations thereof, as used herein, may be defined as an entity or mechanism responsible for generating and/or supplying energy. The energy source may include renewable energy sources such as solar panels, wind turbines, and hydroelectric plants, or non-renewable energy sources such as fossil fuel-based generators and nuclear power plants.

The term “energy consumer” and variations thereof, as used herein, may be defined as an entity, machine, device or mechanism that consumes and/or dissipates energy. At times, the term may be used to reference a responsible person or entity that utilizes or draws energy. Examples of energy consumers include an individual, a business, a utility company, or a grid operator. One or more energy consumers may be associated with an energy profile. The energy consumers may be residential users, commercial establishments, industrial facilities, electric vehicle charging stations, healthcare facilities, industries, utility companies, and so forth, in an embodiment of the present invention. The energy consumers may also include energy brokers, energy storage systems, and microgrid operators that may consume, store, or redistribute energy, in another embodiment of the present invention. Additionally, the energy consumers may involve entities that may participate in energy lending, energy borrowing, or trading markets, as well as those who may seek to optimize their energy usage based on sustainability goals, in yet another embodiment of the present invention. Embodiments of the present invention are intended to include or otherwise cover any suitable energy consumers.

Further examples of energy consumers include energy-associated machines, that may be heat pumps, Heating, Ventilation, and Air Conditioning (HVAC) systems, electrical appliances such as, refrigerators, washing machines, dishwashers, ovens, and microwaves, generators, electric vehicles, battery storage systems, lighting systems such as LED lights, streetlights, and emergency lighting, air conditioners, water heaters, industrial machinery, such as conveyor belts, pumps, and compressors, automated manufacturing equipment, data centers, computers, mobile phones, smart gadgets, servers, processors, smart home devices, such as, thermostats, smart plugs, and security systems, agricultural equipment, such as irrigation pumps and greenhouse climate control systems, electric forklifts, electric-powered construction tools, electric motors in various applications, medical devices such as oxygen machines, ventilators, diagnostic imaging equipment (e.g., MRI and CT scanners), infusion pumps, patient monitoring systems, and other critical healthcare infrastructure powered by electrical systems and so forth. Embodiments of the present invention may be intended to include or otherwise cover any suitable type of the energy-associated machines, including known, related art, and/or later developed technologies.

The term “energy storage facilities” and variations thereof, as used herein, may be defined as infrastructure, systems, and/or energy-associated machines and/or devices that may be capable of storing energy. The storage facilities may function both as energy consumers and energy sources, dynamically shifting roles as needed based on one or more demands, supply conditions, grid requirements, and so forth.

The term “user” and variations thereof, as used herein, may be defined as a person or an entity that engages with an energy accounting system. Such users may perform functions such as viewing, managing, and/or analyzing energy transactions, generating reports, and/or facilitating energy trading. The user may interact with the energy accounting system through a user interface, and the interactions may be logged for audit and compliance purposes.

The term “administrator” and variations thereof, as used herein, may be defined as a person or an entity that may have advanced access rights within the energy accounting system. The administrator may be responsible for tasks such as configuring system settings, managing user accounts and permissions, enabling data integrity, overseeing compliance with regulatory requirements, and maintaining overall system security. The administrator may have an ability to audit transactions, modify system parameters, and troubleshoot technical issues. The actions performed by the administrator may be logged in the energy accounting system for tracking and compliance purposes.

The term “energy-related attributes” and variations thereof, as used herein, may be defined as distinguishing characteristics and/or properties of energy related-transactions or certificates. The energy-related attributes may include a type of energy (e.g., renewable or non-renewable), a provenance of energy, a quantity of energy, an energy efficiency rating, an energy source type, a certification status, a provenance, a carbon impact, a time, and/or other relevant parameters may be used for indexing and reporting in the energy accounting system.

The term “energies” and variations thereof, as used herein, may be defined as various forms of energy, including electrical energy generated from renewable and non-renewable energy sources. The energies may be categorized based on their provenance of generation, such as solar, wind, hydro, fossil fuel, or nuclear, and may be tracked, managed, and traded within the energy accounting system.

The term “certificate” and variations thereof, as used herein, may be defined as a digital document that certifies the energy-related attributes of one or more energies. The certificates may be generated to validate energy's compliance with certain standards and may be tokenized and/or incorporate cryptographic tokens for use in energy trading.

The term “provenance” and variations thereof, as used herein, may be defined as the documented history or origin of energies, including details about how and where energies were generated, stored, transmitted, and/or consumed. The provenance may enable a traceability and an accountability in energy transactions and may be used to authenticate energy sources, contributing to sustainability and compliance reporting.

The term “chain of custody” and variations thereof, as used herein, may be defined as a process that enables traceability, accountability, and/or integrity of energies from their point of origin through to their final destination or consumption. The chain of custody may involve maintaining a transparent and verifiable record of one or more stages of energy's lifecycle, which may include energy generation, energy aggregation, energy storage, energy distribution, energy consumption, energy re-aggregation, energy de-aggregation, and so forth.

The term “grid network” interchangeably known as “national grid” refers to any suitable centralized electricity infrastructure capable of receiving and distributing energy, including but not limited to: (i) national transmission networks (e.g., National Grid Electricity Transmission in England and Wales), (ii) regional transmission operators (e.g., SPEN, SSEN), (iii) local distribution networks operated by Distribution Network Operators (DNOs), (iv) electricity system operators (e.g., ESO), and (v) equivalent bodies in other jurisdictions. Where the term “national grid” is used it is not intended to refer to the proper noun, “National Grid Electricity Transmission” but rather to the generalized term as defined herein.

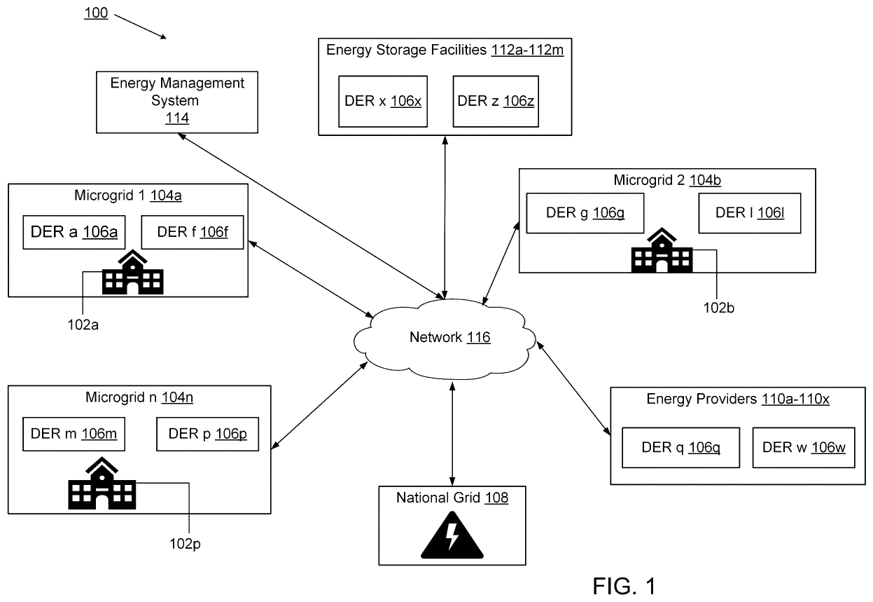

FIG. 1 depicts an exemplary computing environment 100 for managing energies, according to at least one embodiment of the present invention. The computing environment 100 may be capable of managing, organizing, and certifying energy-related transactions. The energy-related transactions may be, for example, an energy generation (i.e., an internal or an external), an energy consumption, an energy transfer, energy storage updates including charging and discharging of an energy storage facility, an energy lending, an energy borrowing, an energy balancing, energy trading activities, energy reconciliation, and so forth. The energy-related transactions may include energy exchanges between different parties, adjustments to energy inventories, and updates to energy credits or debits across various systems.

In an embodiment of the present invention, the computing environment 100 may include a plurality of disparate facilities 102a-102p (hereinafter referred to as “disparate facilities 102” or “disparate facility 102”). The one or more disparate facilities 102 may include one or more educational facilities such as geographically disparate school campuses, geographically disparate college campuses, virtually disparate school campuses, virtually disparate college campuses, and so forth. The one or more disparate facilities 102 may further include one or more vocational facilities, one or more healthcare facilities, one or more administrative facilities, one or more research facilities, one or more commercial facilities and so forth. Embodiments of the present invention are not intended to be limited only to school applications and may be intended to include or otherwise cover any suitable type of the disparate facility 102, including known, related art, and/or later developed technologies.

The one or more disparate facility 102 may include one or more sub-facilities for example, classrooms, laboratories, libraries, auditoriums, administrative offices, student lounges, cafeterias, dormitories, recreational areas, sports facilities such as gymnasiums, swimming pools, athletic fields, computer labs, innovation hubs, research centers, conference rooms, workshops, maker spaces, parking lots, transportation hubs, greenhouses, community gardens, outdoor learning spaces, performance theatres, art studios, music rooms, medical centers and infirmaries, faculty housing, study halls, childcare centers, security offices, maintenance facilities, utility rooms, energy generation facilities such as solar farms, wind turbines, geothermal plants, biomass systems, and so forth, water management systems such as rainwater harvesting, water treatment plants, and so forth, and IT infrastructure hubs such as server rooms, data centers, telecommunication towers, and so forth. Embodiments of the present invention may be intended to include or otherwise cover any suitable type of sub-facilities that may be beneficial to generate energies.

The disparate facilities 102 may further include one or more microgrids 104a-104n (hereinafter referred to as “microgrid 104” or “microgrids 104. The one or more microgrid 104 may further be configured to enable an uninterrupted energy supply during shutdown events, outages, or emergencies.

The one or more microgrids 104 may include one or more Distributed Energy Resources (DERs) 106a-106z (hereinafter referred to as “DER 106” or “DERs 106”). In an exemplary embodiment of the present invention, the microgrid 104a may include the DERs 106a-106f. The microgrid 104b may include the DERs 106g-106l. The microgrid 104n may include the DERs 106m-106p. There may be the DERs 106q-106w that may be associated with the energy providers 110a-110x. Further, there may be the DERs 106x-106z that may be associated with the energy storage facilities 112a-112m.

The one or more microgrids 104 may be configured to operate as localized energy systems that may be capable of generating, storing, distributing, and managing the energies. The one or more microgrids 104 may further be configured to function in conjunction with one or more of a main power grid, a national power grid, or independently in an islanded mode. The DERs 106 may include types of machinery, devices and/or equipment that may be configured to facilitate energy generation, energy consumption, energy storage including receiving and supplying energy, energy management, and/or energy distribution of the energies within the one or more microgrids 104. In an embodiment of the present invention, the DER 106 may include renewable energy generation systems, such as solar photovoltaic panels, wind turbines, biomass generators, or geothermal energy systems, designed to produce energy from sustainable sources. In another embodiment of the present invention, the DER 106 may include energy storage systems, including but not limited to lithium-ion batteries, solid-state batteries, flow batteries, compressed air energy storage (CAES) units, or thermal energy storage systems, that may be capable of retaining energy for future use during periods of increased demand or reduced generation capacity. The DER 106 may further include backup power generation systems, such as diesel generators, natural gas turbines, or fuel cells, configured to provide supplemental energy during outages or other disruptions to primary energy sources. In some embodiments of the present invention, the DER 106 may integrate advanced power conditioning equipment, including smart inverters and power management systems, to establish a compatibility with the microgrid 104 and to maintain stability in voltage and frequency levels during energy transmission.

The DER 106 may also incorporate demand response functionality, enabling dynamic adjustment of energy usage based on real-time conditions, including grid requirements or time-sensitive pricing structures. In a further embodiment of the present invention, the DER 106 may include combined heat and power (CHP) systems, designed to generate electricity while simultaneously capturing and utilizing waste heat for heating or cooling applications across the disparate facilities 102.

The DERs 106 may include components that may be configured to facilitate energy generation, energy storage, energy management, and energy distribution of the energies within the one or more microgrids 104. Embodiments of the present invention may be intended to include or otherwise cover any suitable type of the components to facilitate the energy generation, the energy storage, the energy management, and the energy distribution, including known, related art, and/or later developed technologies.

According to embodiments of the present invention, the computing environment 100 may further include one or more grid networks (national grids) 108, and the one or more energy providers 110a-110x (hereinafter referred to as the “energy provider 110” or the “energy providers 110”).

The one or more grid networks (national grid) 108 may be configured to serve as a centralized energy distribution network capable of delivering the energies in the computing environment 100. In an embodiment of the present invention, the one or more grid network (national grid) 108 may include, for example, high-voltage transmission lines and associated infrastructure that may be designed to transport electricity from power generation to regional and local distribution networks. The grid network (national grid) 108 may be configured to interface with the one or more microgrids 104 located within the disparate facilities 102 to allow bidirectional energy flow to facilitate the transfer of surplus energy generated by the microgrids 104 back to the grid network (national grid) 108 or vice versa. The interfacing of the one or more microgrids 104 may be managed through an advanced grid-tied predictive energy management system 114, according to the embodiments of the present invention.

The one or more energy providers 110 may be enabled to supply the energies to the grid network (national grid) 108 and/or directly to the microgrids 104 within the disparate facilities 102. The energy providers 110 may also receive energy surplus from the microgrids 104 through the bidirectional flow facilitated by the grid-tied predictive energy management system 114.

The energy providers 110 may be enabled to utilize real-time data from the predictive energy management system 114 to optimize distribution of the energies, forecast demands of the energies, and minimize a wastage of the generated energies.

The energy providers 110 may include the one or more DERs 106q-106w, for example, renewable energy systems such as solar panels, wind turbines, hydroelectric plants, geothermal units, biomass energy systems, tidal and wave energy converters, concentrated solar power systems, or floating solar farms; conventional sources such as coal-fired power plants, natural gas turbines, diesel generators, or nuclear reactors; advanced technologies such as hydrogen fuel cells, energy storage systems, fusion energy reactors, thermoelectric generators, or waste-to-energy systems; modular reactors, microbial fuel cells, algae-based bioenergy generators, piezoelectric energy harvesters, artificial photosynthesis systems, and so forth. According to the further embodiments of the present invention, the one or more energy providers 110 may be, for example, utility companies, renewable energy firms, other entities responsible for generating, storing, and/or distributing the energies, and so forth. Embodiments of the present invention may be intended to include or otherwise cover any suitable type of the energy providers 110. Embodiments of the present invention may be intended to include or otherwise cover any suitable type of the energy providers 110, including known, related art, and/or later developed technologies.

The one or more energy providers 110 may be configured to supply scalable energies to one or more of the grid network (national grid) 108, the one or more microgrids 104, and so forth. In an embodiment of the present invention, the one or more energy providers 110 may be configured to enable a unidirectional energy flow such as the energies may be from the one or more energy providers 110 to the one or more of the grid network (national grid) 108, or the one or more microgrids 104. In another embodiment of the present invention, the energy providers 110 may be configured to enable a bidirectional energy flow such as surplus energies generated by the microgrids 104 or other distributed systems to be fed back into one or more energy storage facilities associated with the one or more energy providers 110.

In some embodiments of the present invention, the energy providers 110 may prioritize the energies from renewable sources, such as solar or wind, generated locally by the microgrids 104 to promote sustainability and reduce dependency on fossil fuels. Additionally, the energy providers 110 may be enabled to coordinate with the microgrids 104 to implement demand response strategies to enhance an efficiency of an energy ecosystem within the computing environment 100.

According to the embodiments of the present invention, the energy storage facilities 112a-112m (hereinafter refer to as the ‘energy storage facilities 112’ or the ‘energy storage facility 112’) may include the one or more DERs 106x-106z, for example, battery storage systems, pumped hydro storage facilities, flywheels, Compressed Air Energy Storage (CAES), thermal storage units, supercapacitors, gravity-based storage systems, hydrogen-based storage, Liquid Air Energy Storage (LAES), electrochemical storage, thermochemical energy storage, synthetic fuel storage, cryogenic energy storage, and so forth. Embodiments may be intended to include or otherwise cover any suitable type of the energy storage facilities, including known, related art, and/or later developed technologies.

The computing environment 100 may further include the predictive energy management system 114. The predictive energy management system 114 may be configured to manage and optimize energy flows between the one or more microgrids 104, the grid network (national grid) 108, and the energy providers 110.

In an embodiment of the present invention, the predictive energy management system 114 may include a software application stored in a server (not shown). In another embodiment of the present invention, the predictive energy management system 114 may be implemented as a hardware, a firmware, a software, or a combination thereof, managed by a third-party service provider.

According to at least one embodiment of the present invention, the predictive energy management system 114 may be configured to interface the plurality of microgrids 104, the grid network (national grid) 108, and the energy providers 110. The predictive energy management system 114 may further be configured to enable a real-time data exchange, flow optimization of the energies, and a coordination of energy allocation strategies across the computing environment 100. In a further embodiment of the present invention, the predictive energy management system 114 may be deployed on the server that may be a cloud server, an edge computing server, a remote server, a local server, a third-party server, and so forth. Embodiments may be intended to include or otherwise cover any suitable type of the server, including known, related art, and/or later developed technologies.

Further, the computing environment 100 may include a network 116. According to the embodiments of the present invention, the network 116 may enable communication and data exchange across various users, participants, and components of the computing environment 100.

The network 116 may include a data network such as the Internet, Local Area Network (LAN), Wide Area Network (WAN), Metropolitan Area Network (MAN), etc. In certain embodiments of the present invention, the network 116 may include a wireless network, such as a cellular network, and may employ various technologies including Enhanced Data Rates For Global Evolution (EDGE), General Packet Radio Service (GPRS), Global System For Mobile Communications (GSM), Internet Protocol Multimedia Subsystem (IMS), Universal Mobile Telecommunications System (UMTS) etc. In some embodiments of the present invention, the network 116 may include or otherwise cover networks or sub-networks, that may include, for example, a wired or wireless data pathway. The network 116 may include a circuit-switched voice network, a packet-switched data network, or any other network capable of carrying electronic communications. For example, the network 116 may include networks based on the Internet Protocol (IP) or Asynchronous Transfer Mode (ATM) and may support voice usage, for example, VoIP, Voice-over-ATM, or other comparable protocols used for voice data communications.

Examples of the network 116 may further include a Personal Area Network (PAN), a Storage Area Network (SAN), a Home Area Network (HAN), a Campus Area Network (CAN), a Local Area Network (LAN), a Wide Area Network (WAN), a Metropolitan Area Network (MAN), a Virtual Private Network (VPN), an Enterprise Private Network (EPN), the Internet, a Global Area Network (GAN), and so forth. Embodiments may be intended to include or otherwise cover any suitable type of the network 116, including known, related art, and/or later developed technologies to connect the components of the computing environment 100 with each other.

In an exemplary embodiment of the present invention, the computing environment may network “p” numbers of the disparate facilities 102a-102p such as a first disparate facility 102a, a second disparate facility 102b and a pth disparate facility 102p. The disparate facilities 102a-102p may include the plurality of the microgrids 104 such as the first disparate facility 102a may include a first microgrid 104a that may further include the DER 106a to DER 106f. Further, the second disparate facility 102b may include the second microgrid 104b which may further include DER 106g to DER 106l. Additionally, the pth disparate facility 102p may include an nth microgrid 104n that may further include DER 106m to DER 106p.

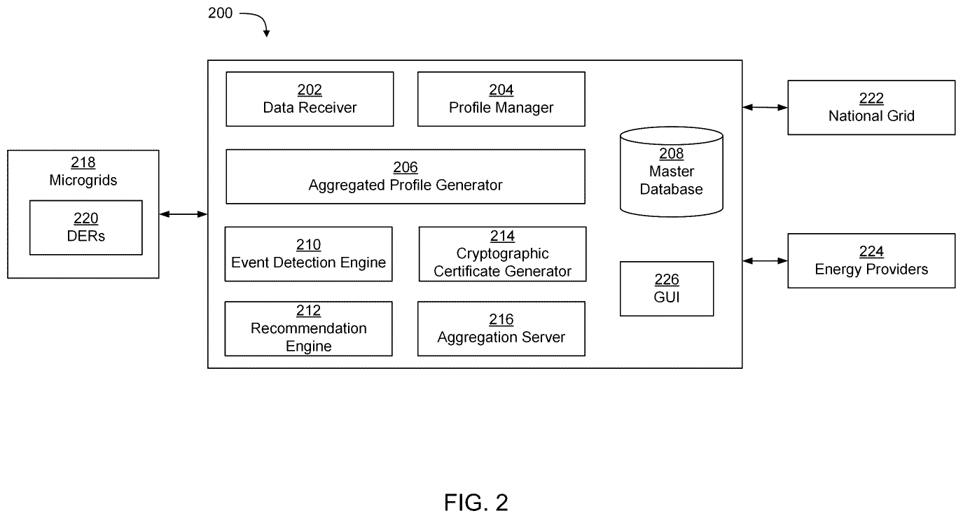

The computing environment 100 may enable efficient energy management, optimization, and energy allocations across the plurality of microgrids 104 through the predictive energy management system 114. For instance, the predictive energy management system 114 may enable an energy allocation among the first disparate facility 102a and the second disparate facility 102b such as a surplus energy from the microgrid 104a of the first disparate facility 102a may be allocated to meet the demand of the microgrid 104b of the second disparate facility 102b in real-time. Further, components and the working of the predictive energy management system 114 may be described in detail in conjunction with the FIG. 2.

FIG. 2 depicts an exemplary functional block diagram of a predictive energy management system 200 in accordance with at least one embodiment of the present invention. The predictive energy management system 200 (FIG. 2) may be an example of the predictive energy management system 114 (FIG. 1). The predictive energy management system 200 may include at least one data receiver 202, at least one profile manager 204, at least one aggregated profile generator 206, at least one master database 208, at least one event detection engine 210, at least one recommendation engine 212, at least one cryptographic certificate generator 214, and at least one aggregation server 216.

According to the embodiments of the present invention, the predictive energy management system 200 may be configured to monitor real-time energy demand, supply, and performance metrics of one or more DERs 220 associated with one or more microgrids 218. The one or more microgrids 218 (FIG. 2) may be an example of the microgrid 104 (FIG. 1) and the one or more DERs 220 (FIG. 2) may be an example of the DERs 106 (FIG. 1).

In an embodiment of the present invention, the data receiver 202 may be configured to receive real-time profile data and one or more chart of accounts from the one or more microgrids 218. The profile data may include one or more of data related to energy demand of the one or more microgrids 218, energy generation from the one or more DERs 220, energy consumption patterns of the one or more DERs 220, one or more provenances of the generated energies, one or more carbon credits, one or more energy transfer tariffs, one or more negotiation terms, other operational parameters, and so forth. The profile data may include the one or more energy transfer tariffs associated with a national grid 222, the one or more energy transfer tariffs associated with one or more utilities, and so forth. Embodiments of the present invention may be intended to include or otherwise cover any suitable profile data.

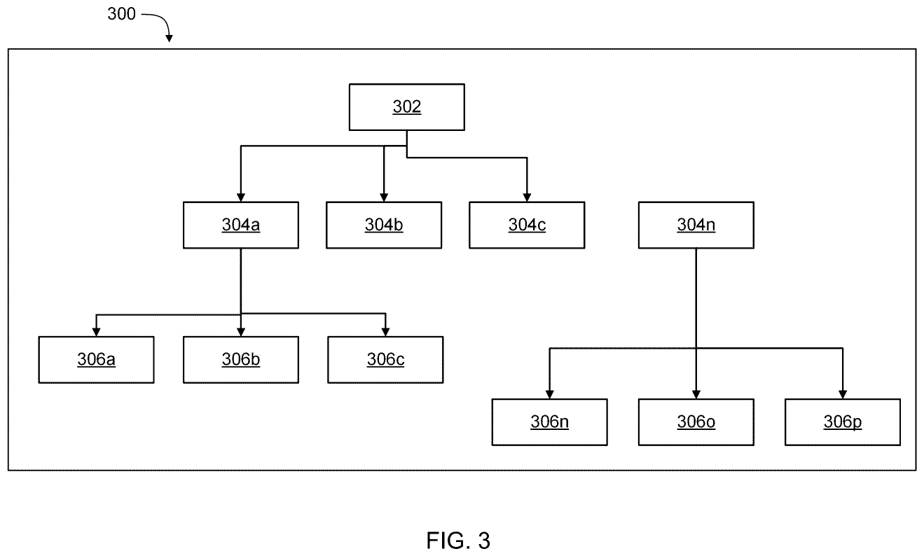

The data receiver 202 may further be configured to receive the profile data and the one or more chart of accounts from external sources, such as the national grid 222 or one or more energy providers 224, to receive relevant grid data or communicate energy transfer requirements to enable the predictive energy management system 200 to track flow of the energies across the one or more microgrids 218 and the national grid 222. The national grid 222 (FIG. 2) may be an example of the grid network (national grid) 108 (FIG. 1) and the one or more energy providers 224 (FIG. 2) may be an example of the one or more energy providers 110 (FIG. 1). The one or more chart of accounts may further be explained in detail in the FIG. 3.

According to the at least one embodiment of the present invention, the profile manager 204 may be configured to store the received profile data from one or more of the one or more microgrids 218, the one or more DERs 220, the national grid 222, the one or more energy providers 224, and so forth. The profile manager 204 may further be configured to compile the received profile data in one or more formats suitable for analysis and decision-making by the predictive energy management system 200. The profile manager 204 may further be configured to enable authorized users to at least visualize, using a Graphical User Interface (GUI) 226, the compiled profile data corresponding to the one or more of the one or more microgrids 218, the one or more DERs 220, the national grid 222, the one or more energy providers 224, and so forth.

According to the embodiment of the present invention, the authorized users may be, for example, one or more energy manager, one or more system administrator, one or more campus facility operators, one or more utility providers, one or more higher authorities, or any other individuals with requisite permissions to monitor the profile data or a part of the compiled profile data. Embodiments of the present invention may be intended to include or otherwise cover any suitable type of the authorized users. The authorized users may have various levels of access, such as the one or more system administrators having a higher-level access, while the one or more campus facility operators may have the access to the part of the compiled profile data.

Further, the profile manager 204 may be configured to transmit the compiled profile data or the part of the compiled profile data to other components of the predictive energy management system 200 such as, the at least one aggregated profile generator 206, the at least one master database 208, the at least one event detection engine 210, the at least one recommendation engine 212, the at least one cryptographic certificate generator 214, the at least one aggregation server 216, and so forth.

According to the at least one embodiment of the present invention, the aggregated profile generator 206 may be configured to fetch, from the profile manager 204, the compiled profile data corresponding to the one or more of the one or more microgrids 218, the one or more DERs 220, the national grid 222, the one or more energy providers 224, and so forth.

In an embodiment of the present invention, the aggregated profile generator 206 may further be configured to generate one or more aggregated profiles for the one or more microgrids 218 that may consolidate the fetched profile data into a unified interpretation. The one or more aggregated profiles may further include the one or more chart of accounts corresponding to the one or more microgrids 218. The one or more aggregated profiles created by the aggregated profile generator 206 may include a hierarchical structure of information.

The aggregated profile generator 206 may be configured to associate one or more energy transfer tariffs with the one or more aggregated profiles to enable a comprehensive financial analysis of the distribution of the energies. The energy transfer tariffs may include factors such as a time-based pricing, congestion fees, transfer losses, and so forth. The aggregated profile generator 206 may be configured to share the one or more aggregated profiles with the other components of the predictive energy management system 200.

According to at least one embodiment of the present invention, the master database 208 may be configured to store the compiled profile data corresponding to one or more microgrids 218, one or more Distributed Energy Resources (DERs) 220, the national grid 222, one or more energy providers 224, and other related entities within the predictive energy management system 200. The master database 208 may further be configured to store energy-related data, such as the one or more aggregated profiles, including the charts of accounts, one or more cryptographic certificates, metadata associated with the one or more cryptographic certificates, and so forth. The master database 208 may also store historical data on energy allocation, one or more triggering events, the one or more energy transfer tariffs, one or more carbon offset transactions, and so forth. Embodiments of the present invention may be intended to include or otherwise cover any suitable type of data in the master database 208, including known, related art, and/or later developed technologies.

In an embodiment of the present invention, the master database 208 may be a Relational Database Management System (RDBMS), such as MySQL or PostgreSQL, that may be used to store structured data of the one or more aggregated profiles, or the energy-related data with fixed relationships. In another embodiment of the present invention, the master database 208 may be a NoSQL database that may be employed to handle large volumes of unstructured or semi-structured data. In a further embodiment of the present invention, the master database 208 may be a Graph Database (e.g., Neo4j), an Object-Oriented Database, a Distributed Database (e.g., Cassandra), a Cloud-Based Database, such as Amazon RDS or Google Cloud SQL, and so forth. Embodiments of the present invention may be intended to include or otherwise cover any suitable type of the master database 208, including known, related art, and/or later developed technologies.

According to at least one embodiment of the present invention, the event detection engine 210 may be configured to monitor the one or more aggregated profiles generated by the aggregated profile generator 206. The event detection engine 210 may further be configured to detect the one or more triggering events associated with the one or more microgrids 218.

The one or more detected triggering events may indicate a benefit and/or requirement to energy reallocation, according to an embodiment of the present invention. The one or more triggering events may include, energy surpluses, deficits, manual requests, reduced energy demand due to shutdown events, such as, holidays, strikes, quarantines, and so forth, or an increased energy demand caused by high-demand events, such as, weather anomalies, extended operational hours, large gatherings, and so forth. Embodiments of the present invention may be intended to include or otherwise cover any suitable triggering events that may indicate the benefit and/or requirement for energy allocation corresponding to the one or more microgrid 218.

The event detection engine 210 may further be configured to identify real-time operational conditions affecting the plurality of microgrids 218 and/or the associated DERs 220.

According to an embodiment of the present invention, the event detection engine 210 may further be configured to detect anomalies and/or deviations from expected operational parameters. In an embodiment of the present invention, the event detection engine 210 may be configured to generate a buffer based on an error rate of historical data. The generated buffer may account for operational inconsistencies in the energy demands, energy generation discrepancies, or unexpected energy outages. By continuously analyzing historical error rates, the event detection engine 210 may be configured to predict error events that may require adjustments in the energy allocation strategies.

According to an embodiment of the present invention, the event detection engine 210 may further be configured to perform batched monitoring of the operational parameters. The batched monitoring may enable the event detection engine 210 to reduce processing overhead and/or may enhance an accuracy in detecting the operational inconsistencies by utilizing the historical data and/or the real-time operational conditions affecting the plurality of microgrids 218 and/or the associated DERs 220. In an exemplary scenario of the present invention, the event detection engine 210 may analyze the operational parameters collected over predefined time intervals, such as hourly, daily, monthly, quarterly or yearly, to detect trends, anomalies, or inconsistencies in the performance of the plurality of microgrids 218 and the associated DERs 220. Based on the analyzed operational parameters within a monitoring batch, the event detection engine 210 may identify a potential triggering event, such as a microgrid experiencing an unexpected surplus of energy during peak solar hours or a consistent deviation from predicted storage discharge rates.

The event detection engine 210 may be configured to generate alerts or notifications for the other components of the predictive energy management system 200 based on the one or more detected triggering events and/or the predicted error events.

According to at least one embodiment of the present invention, the recommendation engine 212 may be configured to generate one or more recommendations for the energy allocations in response to the one or more detected triggering events and/or the predicted error events by the event detection engine 210. The one or more generated recommendations may be based on one of more of the one or more aggregated profiles, one or more predictive models, or one or more optimization algorithms.

The recommendation engine 212 may be configured to consider one or more factors such as cost savings, carbon offsets utilization, energy availability, real-time energy transfer tariffs associated with the national grid 222 or energy providers 224, and so forth. Embodiments of the present invention may be intended to include or otherwise cover any suitable type of the factors for generating the one or more recommendations, including known, related art, and/or later developed technologies.

The recommendation engine 212 may be configured to generate one or more batched recommendations based on the batched monitoring of the operational parameters by the event detection engine 210. The one or more batched recommendations may be generated using insights derived from the analyzed operational parameters of the plurality of microgrids 218 and the associated DERs 220 over the predefined time intervals.

Additionally, the recommendation engine 212 may be configured to generate one or more alternative recommendations for energy transfers based on trade-offs among operational criticality, energy demand, cost efficiency, or a combination thereof.

According to at least one embodiment of the present invention, the cryptographic certificate generator 214 may be configured to generate the one or more cryptographic certificates for executed energy allocations. The cryptographic certificates may include energy-related attributes such as transaction timestamps, energy provenance, energy quantities transferred, associated costs, carbon offset credits utilized or generated, and so forth. Embodiments of the present invention may be intended to include or otherwise cover any suitable type of the energy-related attributes, including known, related art, and/or later developed technologies.

In an embodiment of the present invention, the one or more generated cryptographic certificates may be securely stored in the master database 208 and may provide a verifiable and tamper-proof record of energy allocation transactions between the one or more microgrids 218, the DERs 220, and the national grid 222. In an embodiment of the present invention, the one or more generated cryptographic certificates may be stored on a blockchain ledger. The blockchain ledger may be configured to facilitate decentralized, immutable storage and may enable that the records may not be tampered with or altered. The cryptographic certificates may further enable auditing, reporting, and compliance with energy-related regulatory requirements. The one or more generated cryptographic certificates may enable auditing, detailed reporting, and compliance with energy-related regulatory requirements by providing secure, transparent, and verifiable documentation of energy trade-offs among the one or more disparate facilities. According to at least one embodiment of the present invention, the aggregation server 216 may be configured to execute one or more recommended energy allocations generated by the recommendation engine 212. In an embodiment of the present invention, the aggregation server 216 may further be configured to execute the one or more batched recommendations generated by the recommendation engine 212. For instance, the aggregation server 216 may be configured to execute a specific batched recommendation to transfer excess energy from a microgrid A to a microgrid B between 12:00 PM and 2:00 PM, based on a predicted solar energy surplus. In this case, the aggregation server 216 may be configured to transmit control signals to the microgrid A and the microgrid B for the energy transfer from the microgrid A to the microgrid B. The aggregation server 216 may further be configured to dynamically adjust the energy transfer based on the real-time operational data. By executing the batched recommendation, the aggregation server 216 may enable an optimal distribution of the energies at a beneficial time.

The aggregation server 216 may be configured to facilitate communication between the plurality of microgrids 218, the DERs 220, the national grid 222, and the energy providers 224 to enable the energy allocation and energy distribution, effectively. Additionally, the aggregation server 216 may be configured to prioritize the energy delivery based on operational requirements, cost efficiencies, and criticality factors for receiving microgrids from the one or more microgrid 218 or DERs 220. The aggregation server 216 may further be configured to dynamically update the aggregated profiles, reflecting real-time changes in one or more energy transfer tariffs, resource availability, status of the one or more Distributed Energy Resources (DERs), carbon credit availability, operational conditions affecting one or more of the plurality of microgrids, and negotiation terms among the one or more microgrid 218.

In an embodiment of the present invention, the negotiation terms may be pre-configured into the profile data of the one or more microgrids 218. These pre-configured negotiation terms may define conditions such as maximum and minimum energy thresholds, cost preferences, carbon credit utilization limits, priority levels for the energy allocations, and so forth. In another embodiment of the present invention, the negotiation terms may be dynamically set during runtime. These dynamic negotiation terms may be influenced by real-time operational conditions such as the energy surpluses or the energy deficits, market fluctuations in the energy transfer tariffs, unexpected demand shifts, or changes in the carbon offsets availability. The dynamic negotiation terms may involve automated adjustments based on pre-set rules or algorithms such that the aggregation server 216 may be capable of optimizing decisions related to the energy allocation efficiently and adaptively. The aggregation server 216 may be configured to control the negotiation terms to facilitate energy transfer agreements among the one or more microgrids 218, the DERs 220, and other energy sources.

In an embodiment of the present invention, the aggregation server 216 may be further configured to generate one or more reports following the execution of the one or more energy allocations. The one or more generated reports may include a detailed breakdown of energy transfer costs and tariffs, carbon offsets utilized or generated, savings achieved compared to unoptimized energy allocations, and so forth. The one or more generated reports may enable the entities, such as the energy providers 224, regulators, and microgrid operators, to analyze energy allocation processes. Additionally, the one or more generated reports may provide actionable insights into areas for improvement in the energy allocation processes and may demonstrate compliance with energy-related regulatory requirements.

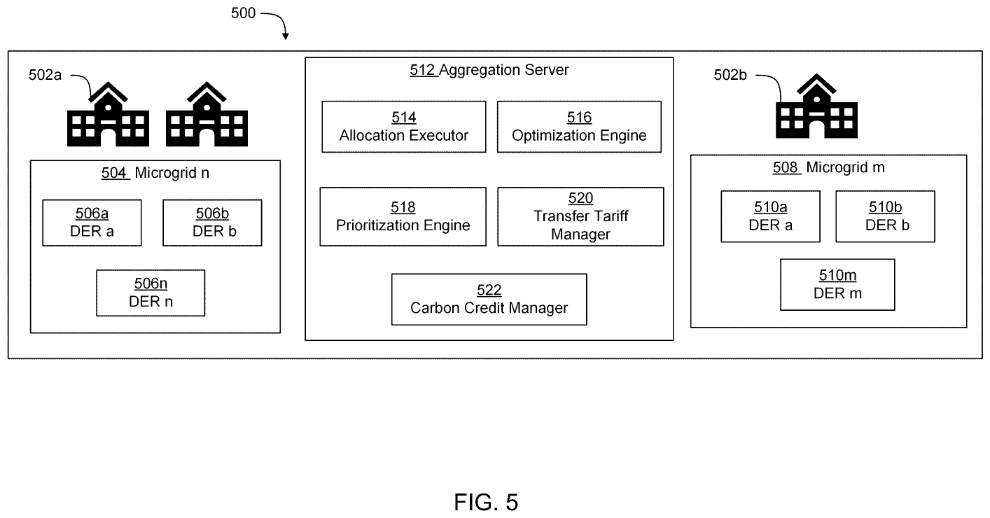

Further, components and the working of the aggregation server 216 may be described in detail in conjunction with FIG. 5.

According to at least one embodiment of the present invention, the GUI 226 of the predictive energy management system 200 may be configured to provide the users with an intuitive interface for interacting with the energy allocation process across the microgrids. The GUI 226 may be configured to facilitate a real-time visualization of the energy generation, the energy consumption, and the energy transfer across the system, allowing users to monitor and control various energy-related parameters. The GUI 226 may further be configured to enable the users to adjust settings, review system status, and receive notifications about energy allocation changes, performance metrics, or system alerts. For example, the GUI 226 may display real-time data on the energy generation from the renewable sources, such as solar or wind, within the one or more microgrids 218. Additionally, the GUI 226 may include a dashboard to visualize the energy consumption patterns across different areas of the disparate facilities. Moreover, the GUI 226 may support interactive features like drag-and-drop scheduling, where the users may adjust energy transfer schedules or modify the operating priorities of specific DERs or loads. The GUI 226 may also be configured to display predictive analytics, and forecasts for energy demand and generation, according to the embodiments of the present invention.

FIG. 3 may be an exemplary block diagram of a chart of accounts 300 in accordance with at least one embodiment of the present invention. The components of the predictive energy management system 200 (FIG. 2) may be referenced to illustrate the chart of accounts 300 (FIG. 3).

In an embodiment of the present invention, the chart of accounts 300 may represent the hierarchical structure that may be used to organize and consolidate the aggregated profile data of the one or more microgrids 218 and the associated one or more DERs 220. The chart of accounts 300 may include at least one root node 302 that may represent the one or more aggregated profiles of the plurality of microgrids 218. In another embodiment of the present invention, the chart of accounts 300 may further include one or more child nodes 304a-300n such as the one or more child nodes 304a-300n may correspond to an individual microgrid 218 within the one or more aggregated profiles. Each of the one or more child nodes 304a-300n may represent detailed energy-related data specific to the one or more associated microgrid 218, such as the energy demand, the energy supply, the historical allocation data, financial attributes, and so forth.

In a further embodiment of the present invention, the chart of accounts 300 may include one or more sub-nodes 306a-306p associated with the one or more child nodes 304a-300n. The one or more sub-nodes 306a-306p may correspond to the one or more DERs 220 within the one or more respective microgrids 218. The one or more sub-nodes 306a-306p may include information associated with the one or more DERs 220, such as energy production capacities, operational status, the associated costs, the carbon offsets, generation potential, and so forth.

According to the at least one embodiment of the present invention, the chart of accounts 300 may be dynamically updated by the predictive energy management system 200 to reflect real-time changes in the energy allocation, the energy transfer tariffs, and DER statuses. The hierarchical structure of the chart of accounts 300 may enable a comprehensive visualization and analysis of the energy distribution and the financial data such that the authorized users may be enabled to efficiently manage energy resources.

The aforementioned example of the chart of accounts 300 may not be intended to limit the scope of the invention or imply specific implementation requirements. Embodiments of the present invention may be intended to include or otherwise cover any suitable modification and enhancement in the structure of the chart of accounts 300, including known, related art, and/or later developed technologies.

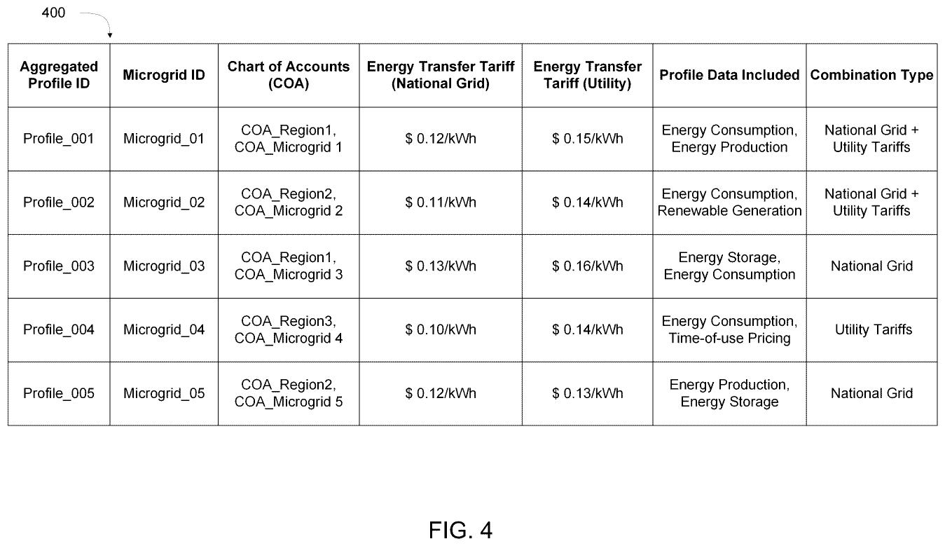

FIG. 4 may be an exemplary aggregated profile 400. The aggregated profile 400 may be generated using the aggregated profile generator 206 (FIG. 2) of the predictive energy management system 200 (FIG. 2) in accordance with at least one embodiment of the present invention. The components of the predictive energy management system 200 (FIG. 2) may be referenced to illustrate the aggregated profile 400 (FIG. 4).

In an exemplary embodiment of the present invention, the aggregated profile 400 may represent a consolidated view of the energy-related data from one or more microgrids 218 within the predictive energy management system 200. In the aggregated profile 400, the one or more microgrids 218 may be assigned with one or more unique identifiers such as Profile_001, Profile_002, and so forth. The one or more unique identifiers may further be associated with a specific microgrid ID such as Microgrid_01, Microgrid_02. The aggregated profile 400 may include components such as one or more Chart of Accounts (COA) (e.g., the “chart of accounts 300” of FIG. 3), the energy transfer tariffs, and the profile data that help in managing energy allocation and ensuring optimal energy use. For instance, the COA for aggregated profile 400 may include hierarchical nodes that may organize and classify data at different levels.

The energy transfer tariffs in aggregated profile 400 may specify the cost of transferring energy between different entities within the predictive energy management system 200, such as the national grid and various utility providers. The energy transfer tariffs may include fixed rates, for instance, $0.12 per kilowatt-hour (kWh) for the National Grid, and $0.15 per kilowatt-hour (kWh) for utility, as well as variable rates based on factors like time-of-use pricing, congestion, or transfer losses. The inclusion of these tariffs may enable a cost analysis and may further aid in determining a cost-effective energy allocation strategy for the one or more microgrids 218.

The profile data included in the aggregated profile 400 may include detailed data sets related to energy flows, such as the energy consumption, the energy production, the renewable energy generation, the energy storage, and so forth. The profile data may be central in forecasting energy needs, planning energy transfers, and optimizing energy consumption. For example, the Profile_001 may include data on both the energy consumption and the energy production, while the Profile_003 may discretely focus on the energy storage and the energy consumption, reflecting the operational needs of one or more microgrids 218. Additionally, the Combination Type in the aggregated profile 400 may represent how the various components of the profile data may be combined, such as by using National Grid+Utility Tariffs as in the Profile_001) or Utility Tariffs alone as in Profile_004, depending on the energy requirements and tariffs associated with the one or more microgrids. This combination may determine the optimal energy allocation strategy to balance the energy generation, the energy consumption, and the energy storage while maintaining cost efficiency and meeting operational goals. Thus, the aggregated profile 400 may enable the predictive energy management system 200 to evaluate energy usage patterns across the one or more microgrids 218. The aggregated profile 400 may further enable the predictive energy management system 200 to facilitate an informed decision-making for the energy transfers and to dynamically optimize the energy distribution across the one or more microgrids 218.

The aforementioned example of the aggregated profile 400 may not be intended to limit the scope of the invention or imply specific implementation requirements. Embodiments of the present invention may be intended to include or otherwise cover any suitable modification and enhancement in the structure of the aggregated profile 400, including known, related art, and/or later developed technologies.

FIG. 5 may be an exemplary block diagram of an aggregation server 512 of a predictive energy management system 500 in accordance with at least one embodiment of the present invention. The predictive energy management system 500 (FIG. 5) may be an example of the predictive energy management system 114 (FIG. 1) or the predictive energy management system 200 (FIG. 2). Further, the aggregation server 512 (FIG. 5) may be an example of the aggregation server 216 (FIG. 2).

The predictive energy management system 500 may be configured to enable the energy allocation between such as disparate facilities 502a-502b. Further, the disparate facilities 502a-502b (FIG. 5) may be an example of the disparate facilities 102a-102p (FIG. 1). The disparate facilities 502a-502b may be, a first disparate facility 502a, a second disparate facility 502b, and so forth.

The first disparate facility 502a may include an nth microgrid 504 that may further include one or more DERs 506a-506n (hereinafter referred to as the “DER 506” or the “DERs 506”). The second disparate facility 502b may include an mth microgrid 508 that may further include one or more DERs 510a-510m (hereinafter referred to as the “DER 510” or the “DERs 510”). The DERs 506 and the DERs 510 may include the types of machinery and equipment that may be configured to facilitate energy generation, energy storage, energy management, and energy distribution of the energies within the one or more microgrids 104.

In accordance with at least one embodiment of the present invention, the aggregation server 512 may include an allocation executor 514, an optimization engine 516, a prioritization engine 518, a transfer tariff manager 520, and a carbon credit manager 522.

In an embodiment of the present invention, the allocation executor 514 may be configured to execute energy trade-offs based on the one or more generated recommendations for the energy allocations. The allocation executor 514 may be configured to fetch the one or more generated recommendations provided by the predictive energy management system 500. Further, the allocation executor 514 may dynamically allocate energy resources across the one or more DERs 506 and DERs 510 to meet the energy demands of the entities, such as the first disparate facility 502a, the second disparate facility 502b, and so forth. By executing these trade-offs, the allocation executor 514 may be configured to optimize resource utilization, reduce costs, and address real-time energy demand, especially during peak periods or emergencies.

In an exemplary scenario of the present invention, once the predictive energy management system 500 generates one or more recommendations for the energy allocation between the first disparate facility 502a and the second disparate facility 502b, the allocation executor 514 may execute the recommended energy trade-offs. If the first disparate facility 502a may be running low on energy due to unexpected demand from air conditioning during a heatwave, the allocation executor 514 may execute one or more energy trade-offs by transferring excess energy from the second disparate facility 502b, which may have a surplus due to favorable solar generation conditions. The allocation executor 514 may also account for factors like energy tariffs and grid pricing and may enable the energy transfer to be done cost-effectively. If the one or more recommended allocations involve any compromise or adjustment, such as reducing energy supply to non-critical loads, the allocation executor 514 may be configured to enable operations at both the disparate facilities 502a-502b may be continued without interruption.

According to at least one embodiment of the present invention, the optimization engine 516 may be configured to optimize the operation of the predictive energy management system 500 by analyzing real-time data, such as energy generation rates, consumption patterns, and weather forecasts. The optimization engine 516 may generate optimal schedules for the energy transfer between the entities, such that a maximum utilization of the renewable energy sources may be enforced by the predictive energy management system 500.

In an exemplary scenario of the present invention, if the first disparate facility 502a experiences cloudy weather that reduces solar energy generation, the optimization engine 516 may be configured to analyze weather forecasts and adjust the energy transfer schedule between the first disparate facility 502a and the second disparate facility 502b. The optimization engine 516 may prioritize energy supply from DERs 510 on the second disparate facility 502b, where solar generation is still at peak levels due to favorable conditions.

In another exemplary scenario of the present invention, if the second disparate facility 502b experiences a drop in energy generation due to cloud cover but may have a high demand for power due to an event, the optimization engine 516 may adjust the energy transfer schedule to allocate energy from DERs 506 at the first disparate facility 502a, which may still be generating the energy at a higher rate. Thus, the optimization engine 516 may be configured to enable the predictive energy management system 500 to safeguard that the energy demand may be met while maximizing renewable energy usage and minimizing the need for grid power.

According to at least one embodiment of the present invention, the prioritization engine 518 may be configured to assign priority levels to various loads within the microgrids 504 and 508. The priority levels may be pre-programmed or dynamically adjusted based on real-time factors, operational requirements, or specific policies set by the disparate facilities 502a-502b. The priority levels may be used to enable systems and functions to receive energy first, especially during periods of limited energy availability, such as during peak demand times or when energy resources are constrained.

For example, loads, such as those required for classroom activities and laboratory operations, may be prioritized over non-critical loads, such as exterior lighting, decorative purposes, and so forth. The prioritization engine 518 may be configured to enable the operations to remain uninterrupted even during periods of limited energy availability.

According to at least one embodiment of the present invention, the transfer tariff manager 520 may be configured to facilitate energy transfer between the microgrids 504 and 508 while calculating transfer tariffs based on energy usage, transfer distance, and other factors. The transfer tariff manager 520 may enable transparency in the energy exchange process and may further enable peer-to-peer trading between entities such as the first disparate facility 502a, and the second disparate facility 502b.

According to at least one embodiment of the present invention, the carbon credit manager 522 may be configured to track and manage the carbon credits associated with the use of the renewable energy sources within the microgrids 504 and 508. The carbon credit manager 522 may be configured to calculate the carbon offset credits achieved through adoption of the renewable energy resources. The achieved carbon offset credits may be added in one or more digital wallets corresponding to the entities, such as the first disparate facility 502a, the second disparate facility 502b, and so forth. The one or more digital wallets may be managed by the predictive energy management system 500.

The one or more digital wallets may enable a transfer or a sale of the carbon credits on trading platforms to promote environmentally sustainable practices. By integrating blockchain technologies or other secure ledger technologies with the one or more digital wallets, may be configured to provide a transparent and tamper-proof record of the carbon credits earned and used.

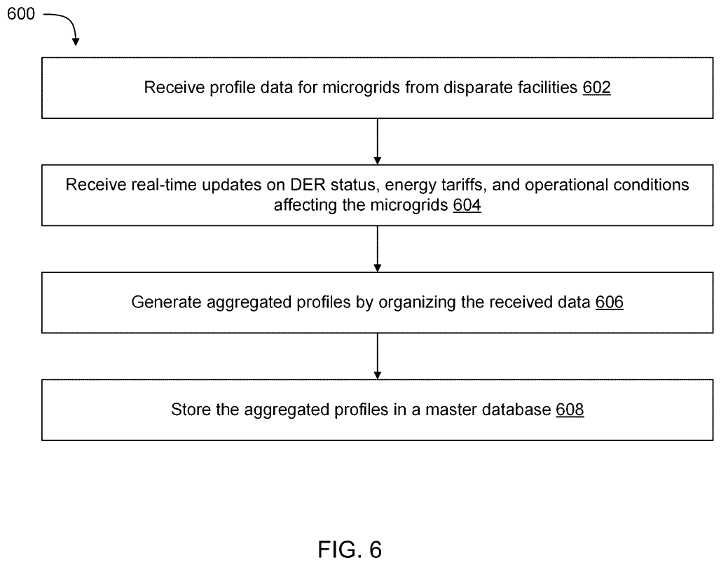

FIGS. 6-8 present illustrative one or more processes 600-800 for implementing predictive energy management systems in accordance with at least one embodiment of the present invention. It is to be understood that the processes 600-800, as illustrated in the FIGS. 6-8, may be described in accordance with at least one embodiment of the present invention without direct reference to specific numerals of the components depicted corresponding to the predictive management system 114 (FIG. 1), the predictive energy management system 200 (FIG. 2) or the predictive energy management system 500 (FIG. 5). The omission of specific numerals for components in describing the processes 600-800 may not limit the scope of the invention, and the processes 600-800 may be implemented using any suitable configuration or arrangement of the components described in the predictive management system 114 (FIG. 1), the predictive energy management system 200 (FIG. 2) or the predictive energy management system 500 (FIG. 5).

The one or more processes 600-800 may be illustrated as a collection of blocks in a logical flowchart, which represents a sequence of operations that may be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform particular functions or implement particular abstract data types. The order in which the operations may be described may not be intended to be construed as a limitation, and any suitable number of the described blocks may be combined in any suitable order and/or in parallel to implement the process.

FIG. 6 may be an exemplary process 600 of generating the aggregated profile in accordance with at least one embodiment of the present invention.

At 602 block, the predictive management system may receive the profile data for the plurality of microgrids from the disparate facilities. The profile data may include the one or more data related to the energy demand of the one or more microgrids, the energy generation from the one or more DERs, the energy consumption patterns of the one or more DERs, the one or more provenances of the generated energies, the one or more carbon credits, the one or more energy transfer tariffs, one or more negotiation terms, other operational parameters, and so forth. The profile data may include the one or more energy transfer tariffs associated with the national grid, the one or more energy transfer tariffs associated with the one or more utilities, and so forth. Embodiments may be intended to include or otherwise cover any suitable profile data. The received profile data may provide a foundation for analyzing unique energy characteristics and behaviors of the one or more microgrids for subsequent aggregation and profiling.

At 604 block, the predictive management system may receive real-time updates on DER status, the energy transfer tariffs, and the operational conditions affecting the plurality of microgrids. The received real-time updates may further include the operational performance of DERs, changes in the energy transfer tariffs that influence costs, and factors such as weather conditions, equipment status, or energy demand variations. By integrating these updates, the data remains accurate and reflective of current operating environments.

At 606 block, the predictive management system may generate the one or more aggregated profiles by organizing the received profile data. This step may involve consolidating and compiling the profile data received from the plurality of the microgrids into the aggregated profiles that may summarize their energy performance, DER contributions, and cost implications. The one or more aggregated profiles may be structured to provide comprehensive insights into the operational characteristics of the plurality of microgrids without altering the raw essence of the data.

At 608 block, the predictive management system may store the one or more aggregated profiles in the master database. The master database may serve as a centralized repository for the one or more aggregated profiles. The one or more stored aggregated profiles may be accessible by the other components of the predictive management system for further analysis, monitoring, and decision-making.

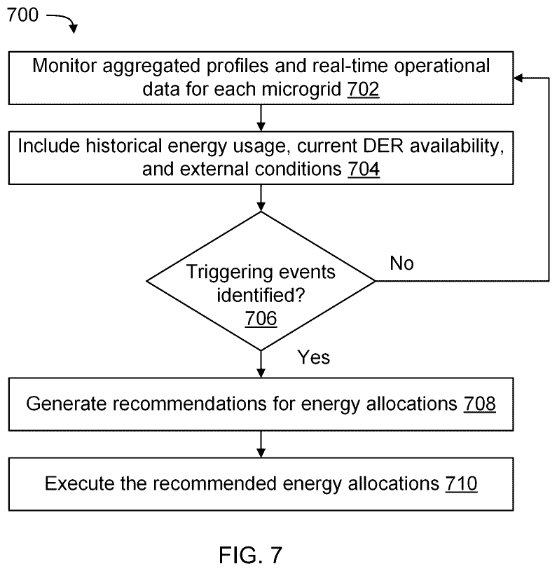

FIG. 7 illustrates an exemplary process 700 for generating the one or more recommendations for the energy allocations in accordance with at least one embodiment of the present invention.

At 702 block, the predictive management system may monitor the one or more aggregated profiles and the real-time operational data for the plurality of the microgrids. This step may involve receiving and analyzing the one or more profile data, which may include the historical energy usage, the energy consumption patterns, availability of the one or more DERs, and external conditions such as weather, energy transfer tariffs, and grid congestion. The predictive energy management system may maintain up-to-date information for accurate forecasting and decision-making.

At 704 block, the predictive energy management system may include the historical energy usage, current DER availability, and external operational conditions to enhance the analysis of the one or more aggregated profiles. By integrating these datasets, the system may generate comprehensive insights for identifying the energy allocation needs. The external conditions, such as time-of-use pricing and environmental anomalies, may further refine the analysis and assist in anticipating energy demand variations.

At 706 block, the predictive energy management system may identify the one or more triggering events indicating a benefit and/or requirement for energy allocation adjustments. These triggering events may include energy surpluses, deficits, manual requests, or changes in operational conditions such as shutdowns (e.g., holidays or strikes) or increased demand (e.g., extreme weather or large gatherings). If no triggering events may be identified, the predictive energy management system may return to the 702 block for continued real-time assessment. In case, one or more triggering events may be identified, then the predictive energy management system may proceed to a 708 block.

At the 708 block, upon detecting the one or more triggering events, the predictive energy management system may generate one or more recommendations for the energy allocations corresponding to the one or more microgrids. The one or more recommendations may be derived using the one or more predictive models. For generating the one or more recommendations, the predictive energy management system may prioritize factors such as cost efficiency, energy availability, and the carbon offsets utilization. The one or more recommendations may also account for the energy transfer tariffs, including time-based pricing, congestion fees, and transfer losses to devise an optimized allocation strategy.

At 710 block, the process 700 concludes by executing the recommended energy allocations. The predictive energy management system may execute the one or more recommended energy allocations through the aggregation server. The aggregation server may facilitate the energy transfers between the one or more microgrids, prioritize delivery to critical resources, or optimize distribution based on the operational requirements. The predictive energy management system may dynamically update the one or more aggregated profiles based on real-time changes to enable an adaptive energy management that responds to shifting conditions of the disparate facilities.

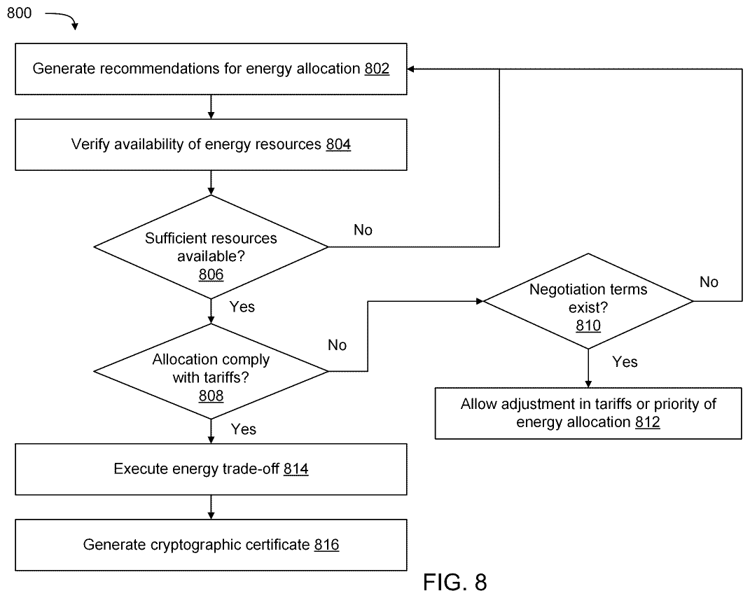

FIG. 8 may be an exemplary process 800 of executing the one or more recommended energy allocations corresponding to the one or more microgrids in accordance with at least one embodiment of the present invention.

At 802 block, the process 800 begins by generating one or more recommendations for the energy allocation. The predictive energy management system may generate the one or more recommendations for the energy allocation corresponding to the one or more microgrids based on the one or more aggregated profiles and the one or more detected triggering events. These recommendations may enable the predictive energy management system to prioritize energy transfers among the microgrids to optimize resource utilization, minimize costs, or fulfill operational demands. For example, Campus A, with a large solar panel array, may generate surplus energy during mid-afternoon, while Campus B, hosting a robotics competition, may experience a spike in electricity demand. The predictive energy management system may generate the one or more recommendations such as for transferring surplus energy from the Campus A to the Campus B to enable uninterrupted event operations and avoid reliance on the grid.

At 804 block, the predictive energy management system may verify the availability of the one or more DERs for the energy allocations. The predictive energy management system may check the current status of the one or more DERs within the microgrids and may further check that sufficient resources are available to implement the recommended allocations. For example, the panel solar array of the Campus A may be confirmed to be operating at 85% efficiency, and a battery storage system of the Campus A may be at 75% capacity. The predictive energy management system may verify that sufficient energy may be available to meet demand of the Campus B without compromising in-campus requirements of the Campus A.

At 806 block, the predictive energy management system may detect if sufficient resources may be available. If the sufficient resources may be available, the process 800 may proceed to a 808 block. Otherwise, the process 800 may return back to the 802 block. For example, if the battery storage of the Campus A falls below 50% due to unexpected cloud cover, the predictive energy management system may re-evaluate and may suggest sourcing additional energy from a Campus C, which also has wind turbines, or scaling down Campus B's energy usage by dimming non-essential lighting.

At the 808 block, the predictive energy management system may evaluate whether the one or more recommended energy allocations comply with applicable energy transfer tariffs. These energy transfer tariffs may include national grid pricing, utility-specific costs, or other transfer-related charges such as congestion fees, time-of-use pricing, and so forth. If the one or more recommended allocation may not comply with the energy transfer tariffs, the process 800 may proceed to a 810 block. Otherwise, the process 800 may proceed to a 814 block.

At the 810 block, the predictive energy management system may detect whether the negotiation terms exist for the one or more microgrid that may be associated with the one or more recommended allocations. For instance, the robotics team of the Campus B may negotiate with the Campus A to prioritize energy transfer even during peak hours by agreeing to cover any additional transfer fees. The predictive energy management system may identify this agreement and may prepare to adjust the priorities or the tariffs accordingly.

If the negotiation terms exists, the process 800 may proceed to 812 block, otherwise the process 800 may return to the 802 block. Upon returning to the 802 block, the predictive energy management system may generate one or more new recommendations for the energy allocation.

At 812 block, the predictive energy management system may allow adjustment in the energy transfer tariffs or priority of the one or more energy allocations. Upon adjustment in the energy transfer tariffs or in the priority of the one or more energy allocations, the process 800 may proceed to the 814 block. For example, the Campus A may be agreed to temporarily prioritize the energy transfer to the Campus B over recharging its campus-wide electric vehicles. Additionally, the Campus B may be agreed to pay a slightly higher fee for the transfer during peak hours to meet the requirements of the energy without disrupting the ongoing activities.

At the 814 block, the predictive energy management system may execute the one or more energy trade-off based on one or more of the complied energy transfer tariffs, the adjusted energy transfer tariffs, or the adjusted priority of the one or more energy allocations.

At 816 block, the process 800 may conclude with the generation of one or more cryptographic certificates. The predictive energy management system may generate the one or more cryptographic certificates for the one or more executed energy trade-offs. The one or more cryptographic certificates may securely record details of the executed energy allocations, including energy-related attributes such as energy volumes transferred, costs incurred, and environmental benefits achieved. For example, the predictive energy management system may generate a cryptographic certificate “CC” for specifying an energy transfer of 100 kWh from the Campus A to the Campus B. The cryptographic certificate “CC” may include timestamped data, costs, adjusted priorities, and the environmental impact (e.g., Carbon offset of 50 kg of CO₂ emissions). The cryptographic certificate “CC” is securely stored in the blockchain ledger for future reference and reporting.

The processes 600-800 may include examples where the predictive energy management system may facilitate efficient energy management across the multiple microgrids of the plurality of disparate facilities. These examples are intended to illustrate the nature of predictive energy management and should not be construed as restrictive.

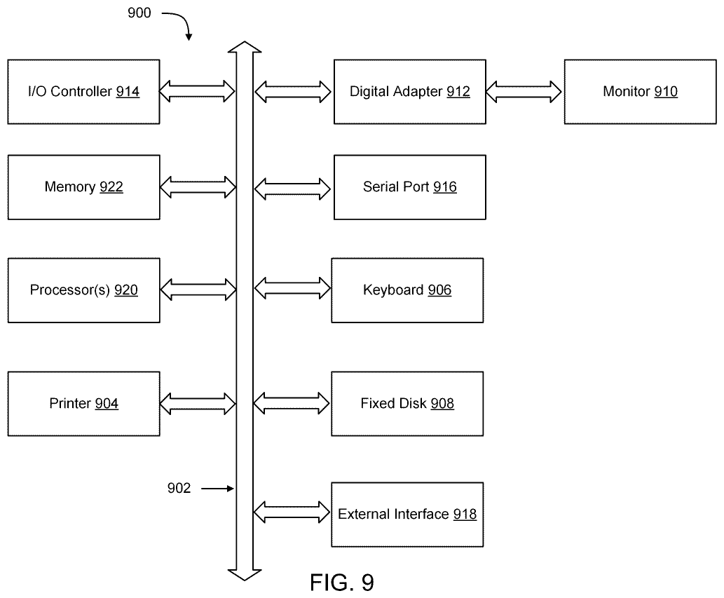

FIG. 9 a schematic diagram illustrating aspects of an example computer in accordance with at least one embodiment of the present invention. In accordance with at least some embodiments, the system, apparatus, methods, processes and/or operations for message coding may be wholly or partially implemented in the form of a set of instructions executed by one or more programmed computer processors such as a central processing unit (CPU) or microprocessor. Such processors may be incorporated in an apparatus, server, client or other computing device operated by, or in communication with, other components of the system.

As an example, the FIG. 9 depicts aspects of elements that may be present in a computer device and/or system 900 configured to implement a method and/or process in accordance with some embodiments of the present invention. The subsystems shown in FIG. 9 are interconnected via a system bus 902. Additional subsystems such as a printer 904, a keyboard 906, a fixed disk 908, a monitor 910, which is coupled to a display adapter 912. Peripherals and input/output (I/O) devices, which couple to an I/O controller 914, can be connected to the computer system by any number of means known in the art, such as a serial port 916. For example, the serial port 916 or an external interface 918 can be utilized to connect the computer device 900 to further devices and/or systems not shown in FIG. 9 including a wide area network such as the Internet, a mouse input device, and/or a scanner. The interconnection via the system bus 902 allows one or more processors 920 to communicate with each subsystem and to control the execution of instructions that may be stored in a system memory 922 and/or the fixed disk 908, as well as the exchange of information between subsystems. The system memory 922 and/or the fixed disk 908 may embody a tangible computer-readable medium.

It should be understood that the present invention as described above can be implemented in the form of control logic using computer software in a modular or integrated manner. Alternatively, or in addition, embodiments of the invention may be implemented partially or entirely in hardware, for example, with one or more circuits such as electronic circuits, optical circuits, analog circuits, digital circuits, integrated circuits (“IC”, sometimes called a “chip”) including application-specific ICs (“ASICs”) and field-programmable gate arrays (“FPGAs”), and suitable combinations thereof. As will be apparent to one of skill in the art, notions of computational complexity and computational efficiency may be applied mutatis mutandis to circuits and/or circuitry that implement computations and/or algorithms. Based on the disclosure and teachings provided herein, a person of ordinary skill in the art will know and appreciate other ways and/or methods to implement the present invention using hardware and/or a combination of hardware and software.

Any of the software components, processes or functions described in this application may be implemented as software code to be executed by a processor using any suitable computer language such as, for example, Java, C++ or Perl using, for example, conventional or object-oriented techniques. The software code may be stored as a series of instructions, or commands on a computer readable medium, such as a random-access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

According to the embodiments of the present invention, the predictive energy management systems may include the one or more processor 920 and the memory 920 for storing instructions. In such an embodiment of the present invention, the instructions stored in the memory 920 may be executed by the memory 920 to perform a set of operations of the predictive energy management system.

The instructions may be in the form of packages of a computer program code. The code, for example, may be written in a computer programming language that may be compiled into a native instruction set of the one or more processor 920. Further, the code may also be written directly using the native instruction set (e.g., machine language) for executing a set of operations. The set of operations may typically include comparing two or more units of information, shifting positions of units of information, and combining two or more units of information, such as by addition or multiplication or logical operations like OR, exclusive OR (XOR), and AND. Each operation of the set of operations that can be performed by the one or more processor 920 may be represented to the one or more processor 920 by information called instructions, such as an operation code of one or more digits. A sequence of operations to be executed by the one or more processor 920, such as a sequence of operation codes, constitutes processor instructions, also called computer system instructions or, simply, computer instructions. The one or more processor 920 may be implemented as mechanical, electrical, magnetic, optical, chemical, or quantum components, among others, alone or in combination. Embodiments may be intended to include or otherwise cover any suitable implementation of the one or more processor 920, including known, related art, and/or later developed technologies.

The use of the terms “a” and “an” and “the” and similar referents in the specification and in the following claims are to be construed to cover both the singular and the plural, unless otherwise indicated herein or clearly contradicted by context. The terms “having,” “including,” “containing” and similar referents in the specification and in the following claims are to be construed as open-ended terms (e.g., meaning “including, but not limited to,”) unless otherwise noted. Recitation of ranges of values herein are merely intended to serve as a shorthand method of referring individually to each separate value inclusively falling within the range, unless otherwise indicated herein, and each separate value is incorporated into the specification as if it were individually recited herein. All methods described herein can be performed in any suitable order unless otherwise indicated herein or clearly contradicted by context. The use of any and all examples, or exemplary language (e.g., “such as”) provided herein, is intended merely to better illuminate embodiments of the invention and does not pose a limitation to the scope of the invention unless otherwise claimed. No language in the specification should be construed as indicating any non-claimed element as essential to each embodiment of the present invention.

Different arrangements of the components depicted in the drawings or described above, as well as components and steps not shown or described are possible. Similarly, some features and subcombinations are useful and may be employed without reference to other features and subcombinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications can be made without departing from the scope of the claims below.

### CONCLUSION

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method for predictive energy management, comprising:
receiving profile data for a plurality of microgrids of a plurality of disparate facilities, wherein the plurality of microgrids comprise a plurality of distributed energy resources (DERs);
creating one or more aggregated profiles, wherein the one or more aggregated profiles comprise one or more of the received profile data and at least one chart of accounts for individual ones of the plurality of microgrids;
detecting one or more triggering events, based on the one or more aggregated profiles, indicating a benefit to energy reallocation;
generating one or more recommendations for one or more energy allocations based on the aggregated profiles and the one or more detected triggering events, using one or more predictive models; and
executing the one or more recommended energy allocations with at least one aggregation server.

2. The method of claim 1, wherein the one or more aggregated profiles further comprise one or more cryptographic certificates comprising energy-related attributes for the executed energy allocations between the individual ones of the plurality of microgrids and through at least one grid network.

3. The method of claim 1, wherein the one or more triggering events are based at least in part on one or more of: energy surpluses, deficits, and manual requests.

4. The method of claim 1, wherein the at least one chart of accounts within the aggregated profiles comprises:
at least one root node representing the one or more aggregated profiles of the plurality of microgrids;
one or more child nodes representing the plurality of microgrids; and
one or more sub-nodes representing the one or more distributed energy resources within the individual ones of the plurality of microgrids.

5. The method of claim 1, wherein detecting the one or more triggering events comprises identifying operational conditions selected from one or more of:
a reduced energy demand due to one or more shutdown events; and
an increased energy demand due to high-demand events.

6. The method of claim 1, further comprising generating one or more alternative recommendations for energy transfer, based at least in part on one or more of: real-time trade-offs among cost savings, carbon offset utilization, and energy availability.

7. The method of claim 1, wherein the profile data comprises one or more energy transfer tariffs associated with at least one grid network, one or more energy transfer tariffs associated with one or more utilities, or a combination thereof.

8. The method of claim 7, wherein the energy transfer tariffs associated with the at least one grid network comprises one or more time-based pricings, congestion fees, transfer losses, or a combination thereof.

9. The method of claim 1, further comprising prioritizing energy delivery to the one or more distributed energy resources within one or more receiving microgrids from the plurality of microgrids based at least in part on one or more factors including: an energy demand, an operational criticality, and a cost efficiency.

10. The method of claim 1, further comprising dynamically updating the one or more aggregated profiles to reflect real-time changes in one or more energy transfer tariffs, status of the one or more distributed energy resources, carbon credit availability, operational conditions affecting one or more of the plurality of microgrids, or a combination thereof.

11. The method of claim 1, further comprising generating one or more reports following the execution of the one or more energy allocations, wherein the one or more generated reports comprise a breakdown of energy transfer costs and tariffs, carbon offsets utilized or generated, savings achieved compared to unoptimized energy allocations, or a combination thereof.

12. A system for predictive energy management, comprising:
at least one data receiver configured at least to receive profile data for a plurality of microgrids of a plurality of disparate facilities, wherein the plurality of microgrids comprises a plurality of distributed energy resources (DERs);
at least one aggregated profile generator configured at least to create one or more aggregated profiles, wherein the one or more aggregated profiles comprise one or more of the received profile data and at least one chart of accounts for individual ones of the plurality of microgrids;
at least one event detection engine configured at least to detect one or more triggering events, based on the one or more aggregated profiles, indicating a benefit to energy reallocation;
at least one recommendation engine configured at least to generate one or more recommendations for the one or more energy allocations based on the aggregated profiles and the one or more detected triggering events, using one or more predictive models; and
at least one aggregation server configured at least to execute the one or more recommended energy allocations.

13. The system of claim 12, further comprising at least one cryptographic certificate generator configured at least to generate one or more cryptographic certificates comprising energy-related attributes for executed energy allocations between the individual ones of the plurality of microgrids and through at least one grid network.

14. The system of claim 12, wherein the at least one aggregated profile generator is further configured to create at least one chart of accounts within the aggregated profiles, the at least one chart of accounts comprising:
at least one root node representing the one or more aggregated profiles of the plurality of microgrids;
one or more child nodes representing the plurality of microgrids; and
one or more sub-nodes representing the one or more distributed energy resources within the individual ones of the plurality of microgrids.

15. The system of claim 12, wherein the event detection engine is further configured to detect one or more operational conditions selected from one or more of:
a reduced energy demand due to one or more shutdown events; and
an increased energy demand due to high-demand events.

16. The system of claim 12, wherein the at least one recommendation engine is further configured to generate one or more alternative recommendations for energy transfer, based at least in part on one or more of: real-time trade-offs among cost savings, carbon offset utilization, and energy availability.

17. The system of claim 12, wherein the at least aggregated profile generator is further configured to associate energy transfer tariffs with the at least one grid network, the tariffs comprising one or more of time-based pricing, congestion fees, transfer losses, or a combination thereof.

18. The system of claim 12, wherein the at least one aggregation server is further configured to prioritize energy delivery to the one or more distributed energy resources within one or more receiving microgrids from the plurality of microgrids based on one or more factors including: energy demand, operational criticality, and cost efficiency.

19. One or more computer-readable storage media collectively having thereon computer-executable instructions that, when executed, collectively cause one or more computers to, at least:
receive profile data for a plurality of microgrids of a plurality of disparate facilities, wherein the plurality of microgrids comprises a plurality of distributed energy resources (DERs);
create one or more aggregated profiles, wherein the one or more aggregated profiles comprise one or more of the received profile data, and at least one chart of accounts for individual ones of the plurality of microgrids;
detect one or more triggering events, based on the one or more aggregated profiles, indicating a benefit to energy allocation;
generate one or more recommendations for the one or more energy allocations based on the aggregated profiles and the one or more detected triggering events, using one or more predictive models; and
execute the one or more recommended energy allocations via at least one aggregation server.

20. The one or more computer-readable storage media as claimed in claim 19, wherein the at least one chart of accounts comprises:
at least one root node representing the one or more aggregated profiles of the plurality of microgrids;
one or more child nodes representing the plurality of microgrids; and
one or more sub-nodes representing the one or more distributed energy resources within the individual ones of the plurality of microgrids.
